(19) United States
(12) Patent Application Publication
(10) Pub. No.: US 2007/0191745 A1
(43) Pub. Date: Aug. 16, 2007

(54) Massage device set

(76) Inventor: Una Tucker, London (GB)

Correspondence Address: WILMER CUTLER PICKERING HALE AND DORR LLP, 60 STATE STREET, BOSTON, MA, 02109, US

(21) Appl. No.: 10/585,184

(22) PCT Filed: Dec. 29, 2004
(86) PCT No.: PCT/GB04/05423

§ 371 Date: Jun. 30, 2006

(30) Foreign Application Priority Data
Dec. 30, 2003 (GB) 0330185.0
Feb. 6, 2004 (GB) GB 0402646.4
Mar. 24, 2004 (GB) 0406614.8
Mar. 24, 2004 (GB) 0406613.0
Mar. 24, 2004 (GB) 0406612.2

(51) Int. Cl. A61H 7/00

(52) U.S. Cl. 601/135; 601/15; 601/137

(57) ABSTRACT

The present invention relates to a set of hand-held massaging devices suitable for use in performing various Swedish massage movements for an all-over body massage. The device is designed such that a user can self-massage or a user can assist or perform a massage on a person in need of Swedish or Aromatherapy massage treatment.

### FIELD OF APPLICATION

The present invention relates to a set of hand-held massaging devices for use in providing an all-over ‘head-to-toe’ massage to the body (the “Device”). In the main, the present invention comprises four main tools, each designed for the application of massage on specific parts of the body. They are, respectively, the main body tool, the foot tool, the head tool and the face tool. Each massage device provides specific massage movements relating to a particular area of the body for which they are intended.

In brief, the body tool employs the three standard Swedish massage applications for a general body massage on torso and limbs, that being effleurage (stroking), petrissage (kneading) and frictions (rubbing), in addition to various deep tissue and lymph drainage massage movements. The head tool employs the three main standard Indian Head massage applications of stroking, waving and compression movements, which can be loosely compared to the Swedish massage applications of effleurage, petrissage and frictions, in addition to pressure point therapy. The facial tool relates to a hand-held massaging device for use in the three standard facial massage applications of effleurage (stroking), petrissage (kneading) and pressure point therapy. The foot tool invention relates to a hand-held massaging device(s) used in the application of foot massage involving vibrations, effleurage, petrissage and Reflexology pressure point therapy.

### BACKGROUND

As stated in the introduction, the present invention relates to a set massage devices that are hand-held and require no mechanical or electrical moving parts in order to fulfill their function. In particular, the massage set is useful for the implementation of a range of massage styles, those being “Swedish” or “Aromatherapy” massages (main body tool), Reflexology or pressure point therapy (foot tool), Indian Head massage (head tool) and facial massage (which can comprise of Swedish and Aromatherapy moves and pressure points (face tool)). For the avoidance of doubt, the proposed tools of the set can be used by one individual (the “User”) upon another (the “Recipient”) or they can be employed by an individual in the application of self-massage. In the case of the latter, the terms “User” and “Recipient” will refer to the same individual.

The Swedish and Aromatherapy massage movements applicable to the body tool's usage consist of three basic types of movement: effleurage, petrissage and frictions, in addition to deep tissue and lymph drainage massage movements.

Effleurage consists of long, soothing, stroking movements that are performed using the palm of one or two flat hand(s), pressed gently but firmly onto the skin of the recipient. When massaging the torso and limbs, slightly more pressure is applied when you take the stroke in the direction of the heart (centripetally) to improve lymph and blood circulation. A fairly slow and continuous movement is essential. It is important to keep the flat hand gently pressed onto the skin, moulding onto the contours of the area being massaged, in order to attain an even pressure at all times. Effleurage is always used at the start of a massage, to soothe and help acquaint the area to the massage move. It is also employed at the end of a session to give a relaxing finish to the massage and is also used as a connector stroke - to be used prior to and in between more stimulating strokes or prior to or in between massaging different parts of the body.

Petrissage movements involve various ways of kneading the skin and muscles. These movements help in strengthening the muscle structures by stimulating the layers of tissue and also help in increasing the supply of oxygen/nutrient-rich blood to the area and lymph (waste products) from the area. Kneading motions are employed to work muscle against muscle or muscle against bone or both, thus breaking down tension build-up within the muscles. Petrissage is a firmer movement and usually follows effleurage. Light kneading eases the top muscle layers and is usually used for the elderly, the infirm or the very young, while firmer kneading works on the deeper muscles and is usually employed for most healthy adults. Petrissage is a deeper massage movement and therefore should be generally used on dense muscle areas only as it can discomfort or even pain when applied too heavily to bony areas.

Frictions, also known as connective tissue movements, use the thumb, fingertips or knuckles, to apply deep direct pressure to one particular site of muscular tension. It is very useful for focusing on specific areas of tightness and muscle spasms (especially in the back and neck) and can be employed in a number of ways. Static pressure (also known as trigger point pressure and used in Trigger Point Therapy) is applied by leaning gradually into a point of muscular tension, slowly deepening the pressure without any rotating action and then releasing after a few seconds, all of which helps to release tension and encourage blood/lymph flow. Alternatively, one can also apply small ‘sawing motions’ (employed in cross-fibre or parallel frictions) with stiffened forefingers or tight circular motions using the thumbs (employed in circular frictions). Another form of friction uses the knuckles, knuckling in a loosely clenched motion, to release tension up the sides of the spine, neck and in other areas. One never applies any sort of friction directly to a bony area as the movement is too deep and is likely to result in discomfort.

Deep tissue massage is used to release chronic patterns of muscular tension using slow strokes, direct pressure, or friction. Often the movements are directed across the grain of the muscles (cross-fibre) using the fingers, thumbs, or elbows. This is applied with greater pressure and at deeper layers of the muscle than Swedish massage and that is why it is called deep tissue. It is also more specific, focusing on a specific problem area and then working in all the layers of muscles that might be involved. Because deep tissue massage lends itself to being more focused, it often requires a greater application of controlled force, which can require elevated levels of exertion from the person performing the manoeuvre.

The movements that are applicable to the massage use of the foot tools involve Reflexology (pressure point therapy) and the Swedish massage movements of petrissage, ‘du poing’ effleurage and vibrations.

Vibrations are an application used in Swedish massage that aims to ‘shake’ the muscles in order to release tension and tightness. It is considered to be a great pain reliever, clearing nerve pathways and ‘surprising’ a muscle into releasing its tension. It can either be a stimulating or a relaxing stroke, depending on the needs of the recipient.

Vibrations can include ‘hacking’, ‘tapping’, ‘pounding’ or ‘cupping’. All involve some sort of percussive contact with the recipient's skin and should be brisk and reasonably light (as to avoid injury or discomfort to the recipient).

Petrissage movements involve various ways of kneading the skin and muscles as explained above. Because of the foot's limited spatial area, most petrissage would be a focused petrissage, that being smaller movements in very localised areas. This is a firmer movement and entails working areas of muscle through small circular movements throughout foot's fleshy areas. Light kneading eases the top muscle layers while firmer kneading works on the deeper muscles.

‘Du poing’ (usually performed with the flat part of a fist comprising the area between the proximal inter-phalangeal and metacarpo-phalangeal joints, that being the space between the knuckles of the hand and the middle joint of each finger) is a form of effleurage that can be successfully applied to a small and contoured area such as the foot and entails mono-directional sweeping or ‘scraping’ movements (within the confines of the sole of the foot) that helps increase the circulation of blood and lymph while also providing a relaxing movement that helps break down tension in the muscles of the foot.

Reflexology (pressure point therapy), involves the theory that nerve endings embedded in the feet are connected to meridian lines that flow through all areas of the body and that stimulation of these nerve endings helps to promote balance within these meridian lines thus encouraging relaxation, stimulation of vital organs and the general encouragement of the natural healing processes within the body for the attainment of overall good health. A Reflexology treatment involves massage of the soles and tops of the feet in respect to focused points of pressure. The reflex points are small and precision is important. The user usually employs the thumbs to press on key points on the surface of the foot in order to stimulate the body's natural, self-curative abilities. However, long-term use of the thumbs in Reflexology is a common cause of RSI—the pressure being exerted on the thumbs for the application of Reflexology over an extended period of time has often resulted in semi or permanent damage to the user's thumbs. The devices proposed, however, are specifically designed to carry out both localised petrissage, ‘du poing’ effleurage and the application of Reflexology pressure points without putting undue pressure on the thumbs, or hands, therefore allowing the recipient of the foot massage to experience a longer, more thorough foot massage without fatigue or damage to the user.

The movements that are employed when using the head tool are those involved in a basic Indian Head massage which consists of three types of movement applied directly to the scalp area: stroking (soothing), waving (stimulating) and compression/vibrations (improves blood flow). In addition to the scalp movements, the Swedish massage applications of effleurage, petrissage and frictions can be applied to the neck and shoulders as additional movements in an Indian Head massage routine.

The effects of stroking on the head/body are similar to that of effleurage in Swedish massage. They consist of long, soothing, stroking movements that are performed using the tips of the fingers, pressed gently onto the scalp of the recipient to improve circulation/lymph flow to the scalp and promote relaxation. A fairly slow and continuous movement is essential in order to attain an even pressure at all times. Stroking is always used at the start of a massage, to soothe and help acquaint the area with the massage move. It is also employed at the end of a session to give a relaxing finish to the massage. Stroking is also used as a connector stroke—to be used prior to and in between more stimulating strokes.

The effects of waving movements on the head are similar to that of petrissage in Swedish massage in that it is usually a more forceful stroke that stimulates the skin and muscles of the head. These movements help in strengthening the muscle structures by stimulating layers of tissue and also help in increasing the supply of blood to the area. Such waving motions are employed to work the muscle against the skull, thus breaking down tension build-up within the muscles. At the same time, they also improve the flow of lymph (which basically consists of the blood's waste products). Waving is a firmer movement and usually follows stroking.

Compression technique (similar to Pressure/Trigger Point therapy) is based on Acupressure and uses the fingertips (usually the thumbs) and the ‘heel’ of the hand (comprising of the Hypothenar and Thenar eminences of the palm of the hand) to press key points on the surface of the scalp gently for up to ten seconds in order to release tension, improve blood/lymph flow and stimulate the body's natural self-curative abilities. Acupressure uses the same points as Acupuncture but employs gentle but firm pressure from the fingertips instead of needles. Advantages of using Acupressure include relieving pain, balancing the body's systems and maintaining overall good health. Pressure point therapy in Indian Head massage helps reduce tension, increases the circulation of blood and lymph, and enables the body to relax deeply, thus promoting wellness.

The movements employed by the face tool in carrying out a facial massage include Swedish and Aromatherapy manoeuvres and consist of the three basic types of movements used in Swedish and Aromatherapy routines: effleurage, petrissage and the use of pressure points. Because the face is a smaller and bonier area, all massage strokes would tend to be gentler in pressure and speed of application.

Effleurage, as explained previously, is a sweeping and relaxing stroke that encourages the flow of blood and lymph and is always used at the start of a facial massage, to soothe and help the area become acquainted with the movement, in addition to being employed at the end of a session to give a relaxing finish to the massage. Effleurage is also used as a connector stroke—to be used prior to and in between more stimulating strokes.

Petrissage, as also previously explained, is a firmer movement and usually follows effleurage and usually entails working areas of facial muscle through small circular movements (for the upper face) and larger circular movements (for the lower face). Light kneading eases the top muscle layers while firmer kneading works on the deeper muscles.

Acupressure uses the same points as Acupuncture, but employs gentle but firm pressure from the fingertips instead of needles as defined above. Advantages of using acupressure include relieving pain, balancing the body's systems and maintaining overall good health. Pressure point therapy in facial massage helps reduce tension, increases the circulation of blood and lymph, and enables the body to relax deeply, thus promoting wellness.

### BRIEF DESCRIPTION OF THE FIGURES

In the Figures:

FIG. 1 illustrates the hand held nature of the “Kneader” massage device comprising finger rings or notches (2) and an upper gently-arched dome (1) with tapered sides or 25 edges (3) with a gently convex bottom-most portion of the massage device (4).

FIG. 2 illustrates a perspective view of the Kneader body massage device.

FIG. 3 illustrates a side view of the device wherein finger notches (2) are clearly visible.

FIG. 4 illustrates a bottom view of the Kneader massage device wherein the finger holes (2) are visible and the bottom convex handle (4) is also illustrated as being perfectly ova in conjunction with the top (1).

FIG. 5 illustrates a variation on the Kneader wherein the bottom-most portion (5) of this variation of the device is concave.

FIG. 6 illustrates a perspective view of a Kneader with a concave bottom-most portion of the device.

FIG. 7 illustrates a side view of this concave variation of the Kneader body massage tool.

FIG. 8 illustrates a bottom view of the dome (1) and demonstrates the near oval shape of the upper portion of the device with the widest portion suitable for effleurage and general petrissage.

FIG. 9 illustrates a front view of the facial tool commonly called the “Smoother” comprising a gently rounded arrowhead shape (6a) at the uppermost point of the tool (6b), a crescent-shaped bottom of the tool (7) and two concave u-bend/notches (8a) that graduate out to a rounded top and bottom edges (8b) specifically designed to be used for holding and manipulating the facial tool (8a) and for massaging the jaw line (8b) of the recipient of the massage.

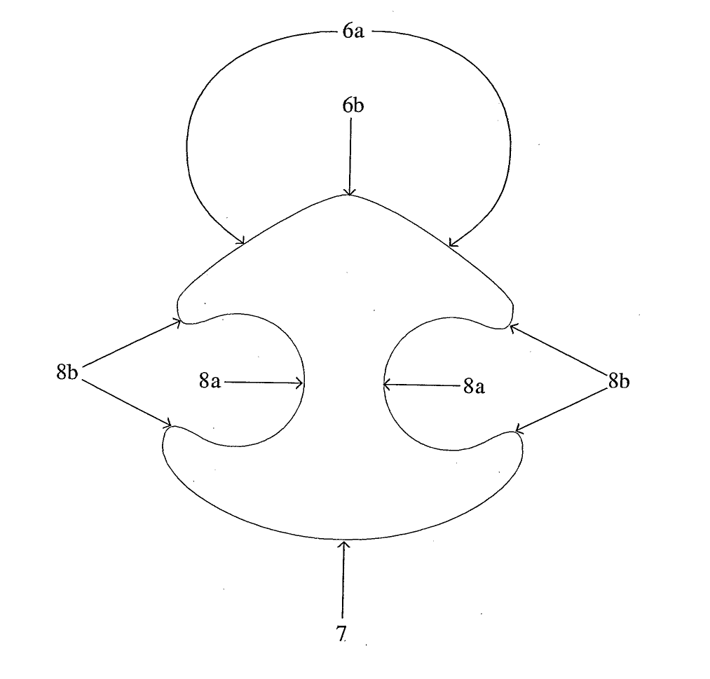

FIG. 10 illustrates a perspective view of the facial tool.

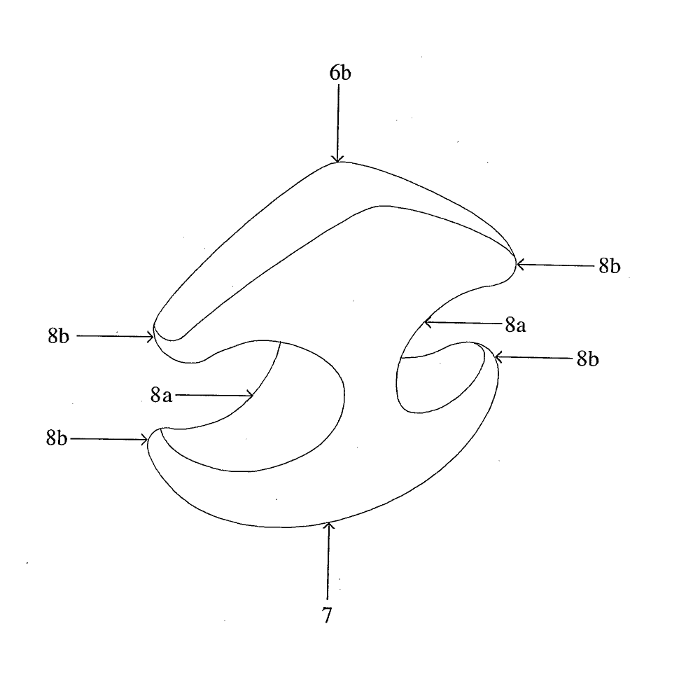

FIG. 11 illustrates a side view of the facial tool.

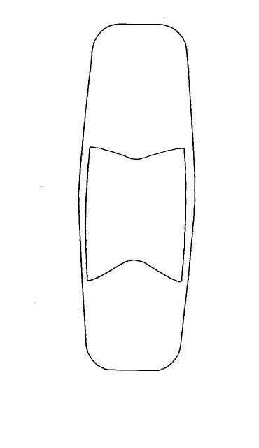

FIG. 12 illustrates a top view of the facial tool and the upper section of the tool (6a) and in particular the arrowhead apex (6b) clearly in view.

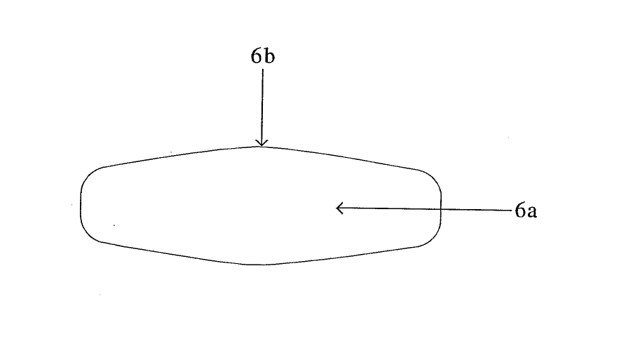

FIG. 13 illustrates a front view of one of the devices forming the foot massage tool set. The tool illustrated in this Figure is commonly called the “Spatula” and works in conjunction with the “Hammer” which is itself illustrated in FIGS. 17, 18, 19 and 20 (although it can perform its own range of useful massage and Reflexology movements independent of the Hammer massage tool). FIG. 13 comprises a circular end portion (9) with a lipped edge (10). The centre of this circular end portion (as illustrated with the hash marks and labelled as (11) in the figure) is flat and surrounded by the lipped edge (10). If the user were to turn this tool over the reverse side of the circular end portion would be identical as the front thus it is immaterial which side of the Spatula tool is employed by the user. The Spatula further comprises a flat middle section (13) which acts as a hand grip for the user of the tool and as progressing towards the lower portion of this device becomes slightly cylindrical and slightly bulbous in nature (12) which then graduates down to a teardrop end point (14) suitable for Reflexology pressure point movements in addition to more focused petrissage movements for smaller and therefore harder to access areas of the foot. The teardrop end also acts as a suitable holding point when employing the circular end of the tool for vibrations.

FIG. 14 illustrates a perspective view of the Spatula and demonstrating the lipped edge nature (10) surrounding the flattened middle of the upper portion of the device (11) as well as the bulbous nature and teardrop end (14) of the lower part of device.

FIG. 15 illustrates as side view of the Spatula device.

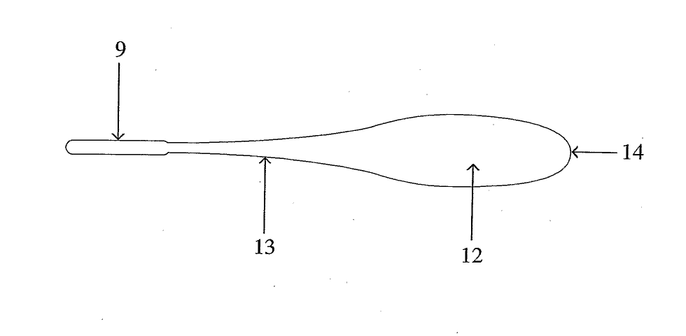

FIG. 16 illustrates the Spatula in top view format.

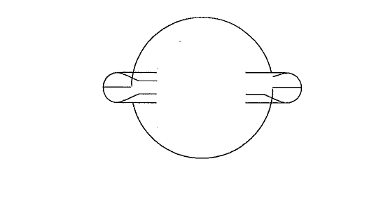

FIG. 17 illustrates the Hammer tool forming part of the foot tool device set (working in conjunction with the Spatula tool illustrated in FIGS. 13-16 herein. This figure shows the Hammer's head (15), which is slightly dome-shaped on the upper portion of the device and the upper portion having an overall shape of a torpedo/ellipse and the centre (16) of the upper portion being wider than the end points (17) of the upper portion of the Hammer (15). This figure further illustrates a middle section (18) which acts as a hand grip for the tool which graduates in size—being wider and flatter at the large upper portion of the device and graduating inwards to become thinner and more cylindrical towards the smaller lower bulbous/orbed portion of the device (19). The smaller, bulbous portion of the device can be used as a hand grip and is of size and weight to act as a counter-weight for the upper portion when said upper portion is used to ‘hammer’ or ‘tap’ when used in conjunction with its sister tool the Spatula. The end points (17) of the upper portion of the Hammer tool ‘tap’ into the centre of the Spatula (11) thereby creating vibrational sensations on the point and surrounding area where the reverse head of the Spatula tool is placed. The upper-most part of the domed portion of the Hammer (20) also functions as an effective surface for du poing effleurage and general effleurage movements on the sole and top of the recipient's foot. The smaller bulbous bottom (19) can also be employed to carry out more general petrissage movements on the larger areas of the foot.

FIG. 18 illustrates a perspective view of the Hammer foot tool.

FIG. 19 illustrates a side view of the Hammer tool.

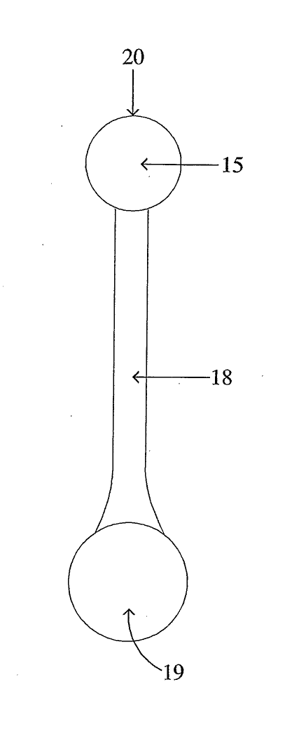

FIG. 20 illustrates a bottom view of the Hammer tool.

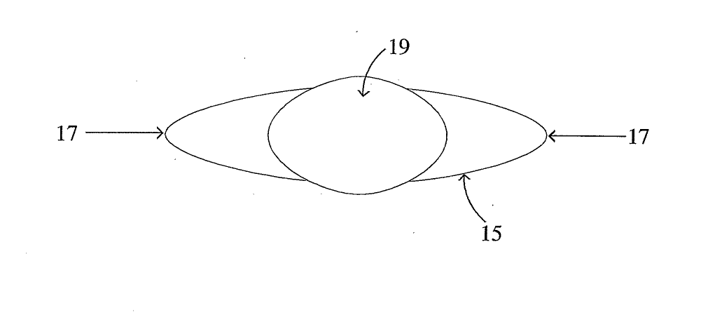

FIG. 21 illustrates the head tool of the massage tool set, commonly called the “Scratcher”, comprising a plurality of finger rings or notches (21), a gently domed top for the application of effleurage to neck and shoulders and/or compressions on the scalp during an Indian Head massage (22), a side finger notch (24), gently rounded tapered extensions or edges on either side of the upper portion of the device (23) providing a useful surface for focused petrissage, a plurality of teeth protruding from the underside of the upper portion of the device for massaging the scalp and invigorating blood flow to the scalp (25) with the teeth having slightly rounded ends so as not tangle or pull at the recipient's hair when the tool is gliding through the hair and for the even distribution of pressure on employment of pressure points to the scalp (26). The space lying between the individual teeth can be employed as a gripping point when utilising the tool in various applications (27).

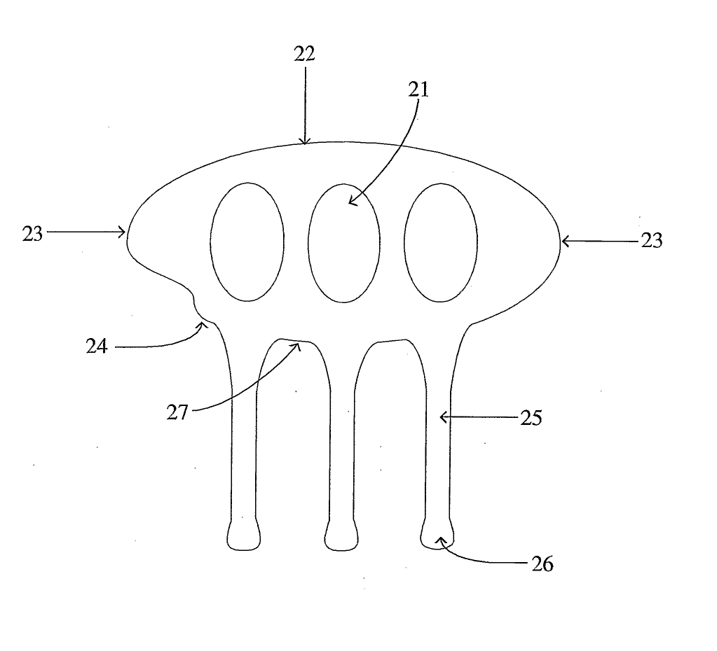

FIG. 22 illustrates a perspective view of the head tool device showing two rows of teeth (25) with three teeth in each row, although alternatively the tool may possess one row of teeth or even more than two rows of teeth. The head tool must simply possess a quantity of teeth (regardless of whether the teeth are fixed into the device in straight rows) so as to stimulate blood flow to the scalp via the massage techniques of Indian Head Massage (i.e. stroking, waving and compression).

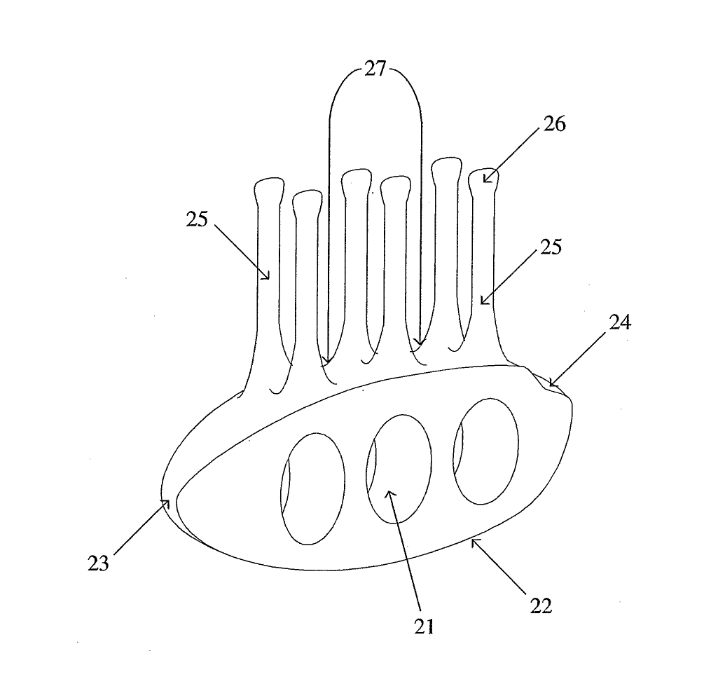

FIG. 23 illustrates a side view of the Head tool known as the Scratcher.

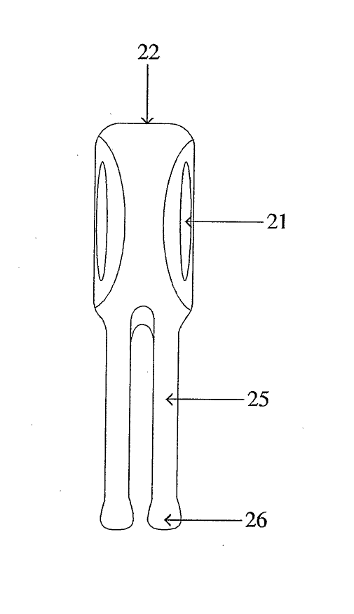

FIG. 24 illustrates a bottom view of the Head tool.

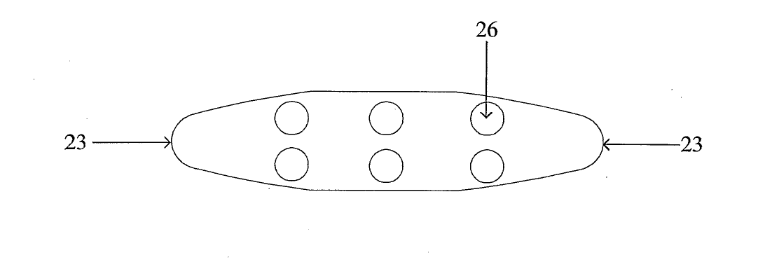

### OBJECTS AND STATEMENT OF THE INVENTION

The various devices comprising the present invention are the body tool, facial tool, head/scalp tool and foot tools. Each of these tools comprises the full complement of tools for an all-over body massage and are described in more detail below.

Body Tool

With regard to the body tool, the object of the present invention is to supply an all-round, self-contained device that is easy to use by the user and provides the recipient with a beneficial massage using the three Swedish massage applications. This particular device forming part of the present invention (called the “Kneader”) is light in weight, possesses no moving or attaching parts, and is completely self-contained and easy to use. The device may be used over clothes or can be applied directly on skin after the application of suitable lubricants.

Various massage implements currently available almost invariably concentrate on only one type of massage movement. This will not necessarily be as beneficial to the recipient and if a tool is used for a massage application that it was not designed, this could potentially result in the recipient experiencing discomfort or injury. Likewise, the user could also experience discomfort or injury by inappropriately using tools for the task at hand. For example, U.S. Pat. No. 6,241,696 (the “696 patent”) relates to a hand-held implement having a number of omni-directional balls, which can be used to provide an effleurage type movement. The limitation of this device is that it cannot fully carry out effective effleurage as, unlike the traditional hand position in this movement, it is not flat. Effleurage is always performed with the palm(s) pressed flatly against the contours of the area being massaged. This is to increase blood flow to the heart and move the lymph around a body to their corresponding (proximal) lymph node(s). The omni-directional balls are bulbous in nature and therefore their spatial effectiveness is limited to the point of where the top point of each orb meets the skin and further results in several spaces of non-contact being created between each consecutive balls as they lie next to each other. The spatial limitation of the moving orb also limits petrissage application, should it be attempted, in that it creates no given or stable point, therefore limiting the required pressure needed for successful petrissage. The result being that the user would overcompensate for this and attempt to apply even more pressure (from the user's hand upon the tool) and this could prove painful if applied too forcefully to one point for any period of time both for the user and the recipient. The bulbous nature of the '696 patent makes it awkward in small spaces (i.e. nape of neck, feet) etc and eliminates the employment of frictions as it cannot be applied to a small, static area. Furthermore, frictions cannot be employed with this patent as the balls move too freely and the intensity of proper friction cannot be maintained. In addition, it cannot be used with oils or creams as residue would build-up in the sockets, thus impairing the balls' omni-directional movement.

Patent WO92/21310 (the “310 patent”) relates to a hand-held device comprising bulbous projections joined together by a connecting frame that can be used for deep pressure, petrissage type movements. Effleurage cannot be properly employed with this device. Its bulbs are not omni-directional and, by way of the frame connecting them, are placed too far apart thus making any sort of gliding movements uneven and possibly painful to the recipient. If too much pressure is applied during an attempt at effleurage, the bulbs (due to the spatial limitation of orb point to skin) will press uncomfortably onto the skin and the connecting frame will create an edge that will scratch the skin. When fully assembled, it creates a square frame with bulbous projections at each corner. The user is then encouraged to insert the forefinger and middle finger into the hollowed centre of the square in order to manipulate the device for massage movement. If, upon insertion of the fingers, the palm is left in the prone (facing downward) position, the fingers would impede any sort of movement, therefore, the palm must be upturned (in the supine position) and the first or second digital area (the distal and/or proximal interphalangeal) of the fingers pressed against the lower part of the frame with the edge of the palm (the Thenar and Hypothenar eminence) resting on the upper part of the frame, which creates stiff, limited hand/wrist movement. The positioning allows a petrissage type movement limited to the area covered by the two connected orbs and their corresponding piece of frame. For the reasons above (limited spatial movement of the orbs and the abrasive edge that the connecting creates) only a very basic and light petrissage can be carried out and although the '310 patent applies itself better to smaller spaces, it cannot work larger areas. It can however, in its dissembled, single orb formation, carry out effective friction movements. There is, however, no adequate support for the user's wrist, and only a very limited movement can be employed with limited pressure. This device therefore cannot be used for a thorough massage and may create wrist/finger joint problems for the user over the long-term. Finally, because this device is not self-contained and can be dissembled for one/two or four orb use, the user cannot place much pressure or movement on the '310 patent, for fear that the device could dissemble mid-movement causing pain and potentially injury to either the user, the recipient or both.

U.S. Pat. No. US 6,241,694 (the “694 patent”) relates to a hand-held device with projections and flat members to accommodate both effleurage, petrissage and friction type movements. This is a self-contained device that can be used with or without oils. It is triangular in shape with a central, triangular void in which the user inserts their hand in order to grip the device for its various uses. It has a straight edge with which to carry out effleurage. Whilst theoretically the straight side has the spatial length needed to carry out effleurage, the limited width of the edge (barely the width of a finger) and its rectangular features creates too much of an edge which, when pressed into a flat area of the body (i.e. back) with any force will create a scraping effect that could cause discomfort and/or pain to the recipient. The same applies for the second, arched edge that is presumably for application of effleurage to rounder body parts such as arms and shoulders. The '694 patent also has a projecting leg member at each point of the triangle and an extended third corner for the application of petrissage and frictions. In applying the three leg members for petrissage movements, the user must turn the 694 patent onto a flat, prone (downward) position and grasp the edges in a twisting motion. This is very awkward on the wrist and hand and requires an effort and dexterity of movement that tires the user quite quickly as well as threatening to over-extend their wrist when applying any force to the movement. As the three leg members are extended from each outer point of the device's triangular shape, this results in the only points of contact on the skin being limited to these members, with large areas of non-contact in between. The leg members are rounded with a concave, arched centre. Because these are small, they create too sharp a point and the concave centre creates a suction that could cause discomfort and/or irritation when force is applied too vigorously. The third, extended edge is for deeper petrissage and/or friction movements. The fingers are inserted into the triangular void and the palm rests on the top edge of the triangle, thus creating the weight needed for friction. Whilst the position is theoretically acceptable for friction movements, in practice, it is ineffective. The extended point is again too small and narrow, with two distinct edges that would prove uncomfortable for deep tissue application. In addition, whilst the positioning of the hand is acceptable for rotating movements, it is unsuitable for the sawing motions needed for frictions in that the device described in the '694 patent encourages the wrist to stiffen and possibly over-extend. Although this device may be multi-functional, it is extremely complicated, requiring a dextrous and skilled hand for proper application that would probably be beyond the capability and patience of the general public. Finally, the central, triangular void is for the insertion of the fingers when applying the device to massage movements. The area is small thus encouraging the fingers to be bunched up, resulting in discomfort and limited supply of blood to the fingers that can lead to cramp. The lack of finger space in the '694 patent also means that the pressure to be exerted whilst performing, for instance, friction movement will not be evenly distributed and thus the resulting massage will not be as effective or enjoyable to the recipient.

The present invention is innovative in that this novel device provides an effective and invigorating massage to the recipient while the design provides maximum comfort to the user of the present invention. The present device may be fashioned from any durable material such as plastic, stone, resin, wood or metal. If the device were to be used with oils or other such lubricating agents then it would be desirable to have the device made from an easily washable material. It is also possible for the device to be made of a material that can be heated, for example, by using hot water or even a microwave and such material should hold the heat for a sufficient period of time (without scalding or burning either the user or the recipient with the heated device during massage), so that the recipient receives the benefit of the use of heat during a massage. Alternatively, it is possible for the upper quadrant of the device (1) to be hollow and a battery-operated heating and/or infrared device to be inserted for heat application during massage.

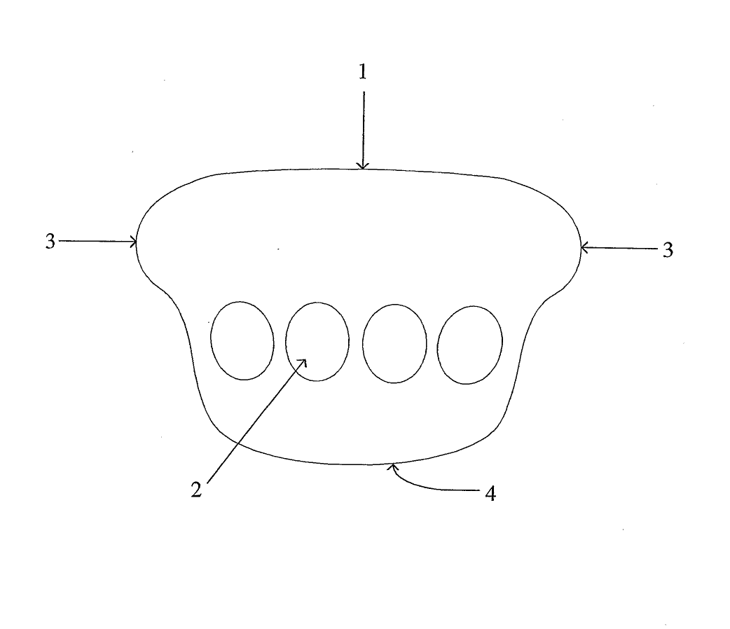

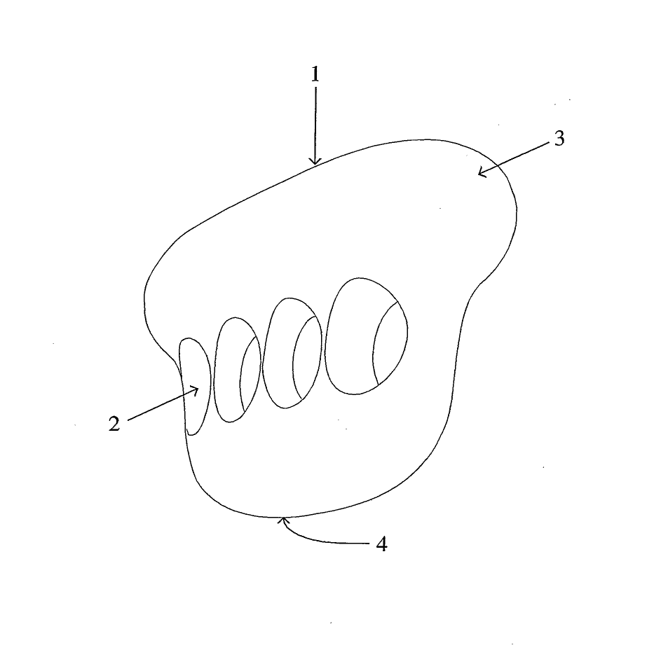

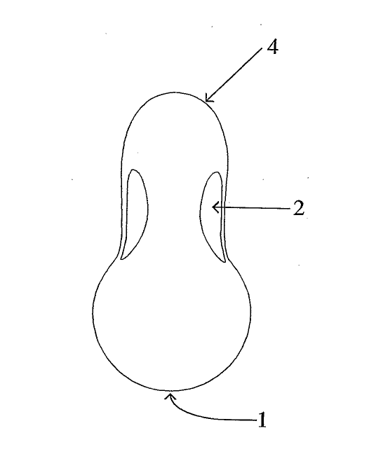

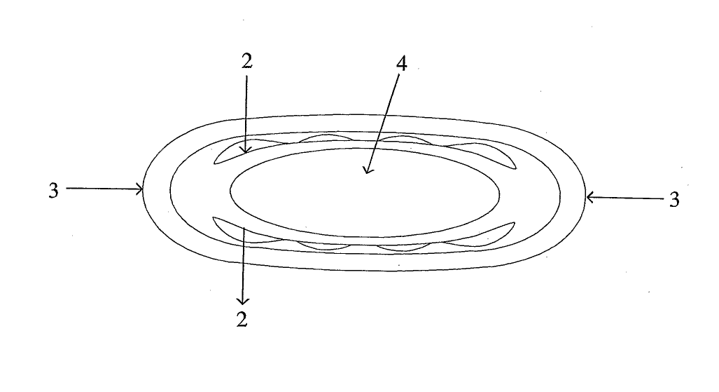

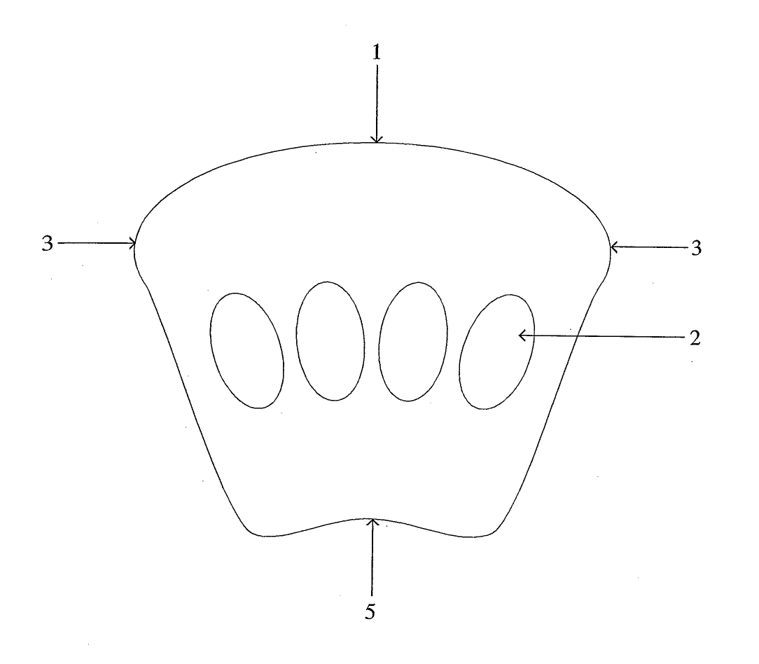

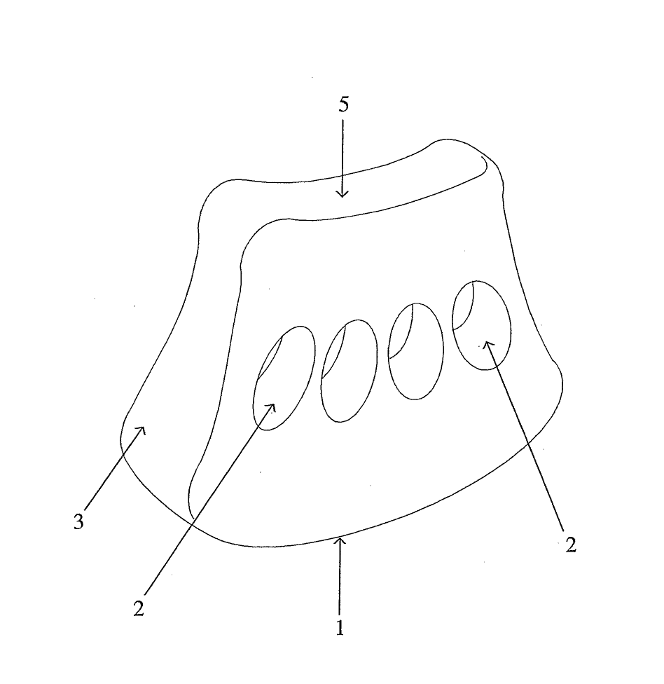

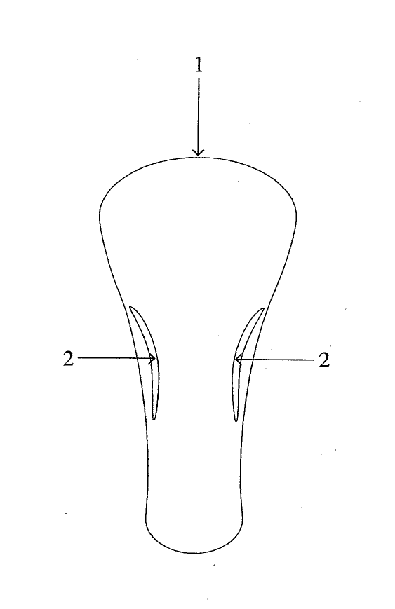

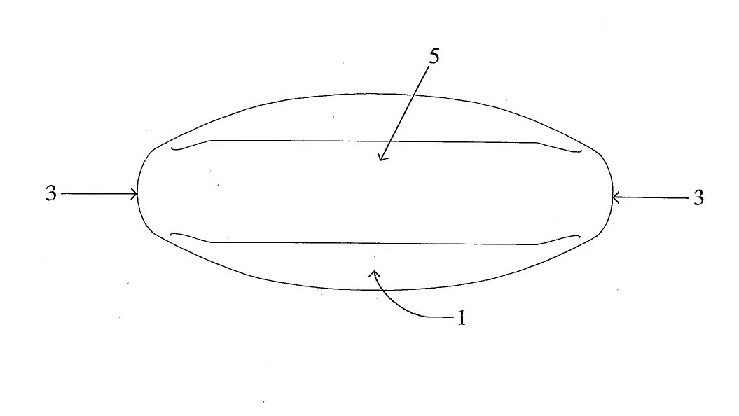

The middle portion of the device comprises individual fingers rings or notches (2) to accommodate the fingers of the user's hand. The fingers are inserted and then close over [around?] the ring portions in a gentle, but firm grip, thus making a fist. The bottom most portion of the present massage device (4) is designed to be a gentle convex shape and to follow essentially the natural curve or thenar and hypothenar eminences of the hand (i.e. the fleshy, bottom part of the palm—the ‘heel’ of the hand) that is formed when making a fist (as illustrated in FIGS. 1-4). The convex nature of the bottom-most position of the present device affords the user a more comfortable and ‘natural’ grip when making a fist once the fingers are inserted in the ring portions, as the heel of the hand will fit naturally over the convex arch. As a result, the device becomes virtually part of the fist, the wrist is supported and the main impetus for the force comes from shoulder and arm movements. This allows the user to apply strong, even pressure with minimal effort and the user can continue doing so for long periods of time, thus benefiting the recipient. Alternatively (as illustrated in FIGS. 5-8) a variation on the Kneader would be that the bottom-most area of the Kneader device would be concave (5). This variation may provide more comfort for the user when using the device, particularly those users with smaller hands as the ‘heel’ of the hand would naturally fit comfortably into the concave proportions of the lower device (5).

The ‘edges’ or ‘corners’ of the device (3) are also to be gently rounded to provide both comfort to the user and ensure that no area of the tool will ‘dig’ or ‘gouge’ into the recipient during a deeper massage (especially one desiring the use of petrissage or friction movements). The upper portion consists of a gently-arched dome (1) made of durable material about approximately 25 mm in height and as wide as the space it occupies, that being the area between the proximal interphalangeal and metacarpo-phalangeal joints (approximately 50mm), and spans the entire width of the closed fist. The upper portion is widest in the middle and gently tapers off towards the edges (3) until it is approximately 10 mm-15 mm on either side of the medial and lateral sides of the hand. The varying widths of the upper part of the device are deliberate and are an essential feature of the present invention. The middle portion of the dome (1) should preferably be wide enough for effleurage and general petrissage purposes whilst the thinner side portions (3) are small enough to carry out focused petrissage and friction movements. The whole of the upper part of the device is gradually and gently arched or domed so that there are no edges (again so that nothing scrapes or pinches the recipient's skin) and for maximum fluidity of movement with regards to the wrist/arm movements and the areas being worked. The upper-most part of the device is wide enough to provide a quasi flat, even surface (for the even distribution of pressure) in order to carry out the wide, sweeping motions of effective effleurage and lymph drainage, yet the dome is small enough to perform effleurage on limbs.

A further advantage of the device is that the rotating motions of petrissage can be performed easily with both the middle and side portions of the upper dome and because the present device has such even and generous spatial range, a maximum coverage can easily be achieved. Due to the device's arched and near circular proportions, the present invention can successfully negotiate difficult areas such as the nape of the neck and forearms with ease and if more concentrated petrissage or friction movements are required, the thinnest part of the device allows circular and sawing motions or even static pressure with concentrated pressure. Such versatility, in application or ease of use, is not available through other massage tools currently available or described in literature. In addition, its gentle, wide arch results in well-balanced, adequate support being provided to the wrist, through the upper and lower portions of the invention, allowing for the application of the increased pressure needed to achieve deep tissue massage which can be of great benefit to the recipient to relieve chronic muscular tension. One of the benefits of this invention is that regardless of the intensity of the pressure, such pressure will be evenly distributed through the device without exhausting the user and it provides beneficial massage and relaxation to the recipient of such a massage. It is also envisaged that the massage device of the present invention can be used with massage oils, lotions or other such suitable lubricants. The design is completely self-contained and hand-held in nature, with no moving parts or detachable elements. The dome (1) can be completely solid or, as a design variation and as a further aspect of the device, can be hollow and filled with water or oil of varying colours. Novelty shapes can be inserted to suit aesthetic or seasonal tastes. Likewise, the dome can be hollow and filled with air or inert gas to make the device lighter. The device can be any colour, according to the manufacturing material used.

Foot Tool Set

With regard to the foot tool, various foot massage implements currently available almost invariably concentrate on one or two basic types of massage movement—either focusing solely on mechanical vibrations or pressure points. Mechanical (motorised) vibrations can either by way of a mechanised hand-held tool or spa (water-based) footbath and tend to be too generalised and often result in a numbing effect on the area of application if used for more than a few minutes. Likewise, Reflexology points, although proven to be effective for the body's well being, do not always provide the soothing effect that tired and sore feet need from a foot massage. In addition, there are several roller type implements on the market that consist of a cylindrical roller, usually wooden and knobbled to provide basic Reflexology points that the recipient can utilise by putting their foot on the cylinder, applying pressure downwards and rolling it back and forth. There are also Reflexology ‘footboards’ that are in the shape and size of a basic foot and doffed all over with Reflexology points. These points are rounded protrusions whereby the user steps onto the board and all the basic Reflexology foot points are stimulated by the weight of the user pressing down on the set protrusions. The individual application of Reflexology points in the aforementioned tools, though theoretically helpful, would not necessarily be as beneficial to the recipient as the multiple applications would be in the proposed tool set (i.e. vibrations, ‘du poing’ effleurage, petrissage and Reflexology pressure points). Furthermore the above mentioned tools are limited to one or two actions only (unlike the proposed tools) and if a tool originally created for an individual application is used for a massage application that it was not designed, this could potentially result in the recipient experiencing discomfort or injury, especially concerning potentially sensitive areas like the soles of the feet. The proposed tools have been designed to carry out all four functions (i.e. vibrations, ‘du poing’ effleurage, petrissage and Reflexology pressure points), even improving on such techniques without undue strain or discomfort to either the user or recipient.

The object of this tool forming part of the present invention is to supply an all-round foot massage device (in this case through two interacting tools) that is easy to manipulate and provides the recipient with a beneficial massage providing the aforementioned foot massage applications. This foot massage device comprises two tools working in conjunction with each other that are light in weight, easy to use and can work just as well together as a single unit or individually, independently of each other. The foot devices are used directly on skin and require no application of lubricants of any kind, although lubricants can be employed if so desired. The device is two-fold, a “Hammer” implement and a “Spatula” implement used in conjunction for the application of vibrations throughout the sole of the foot. The device can, however, be split and each tool used on its own (without employing its twin implement)—the spatula can be individually utilised for the application of localised petrissage and Reflexology pressure points throughout the sole of the foot and the hammer can be individually utilised for the application of ‘du poing’ effleurage and general petrissage on the sole of the foot.

The present invention is innovative in that this novel twin set provides an effective and invigorating massage to the recipient while the design provides maximum comfort and protection to the user of the present invention.

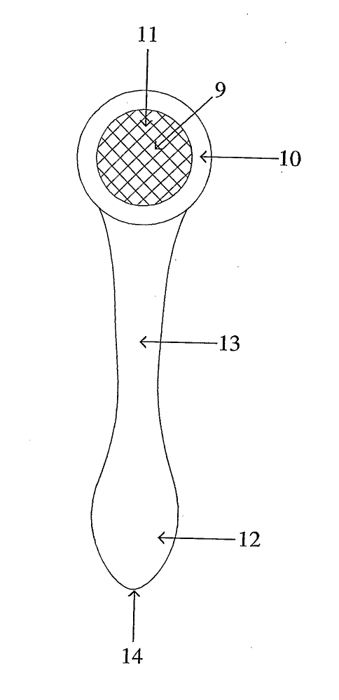

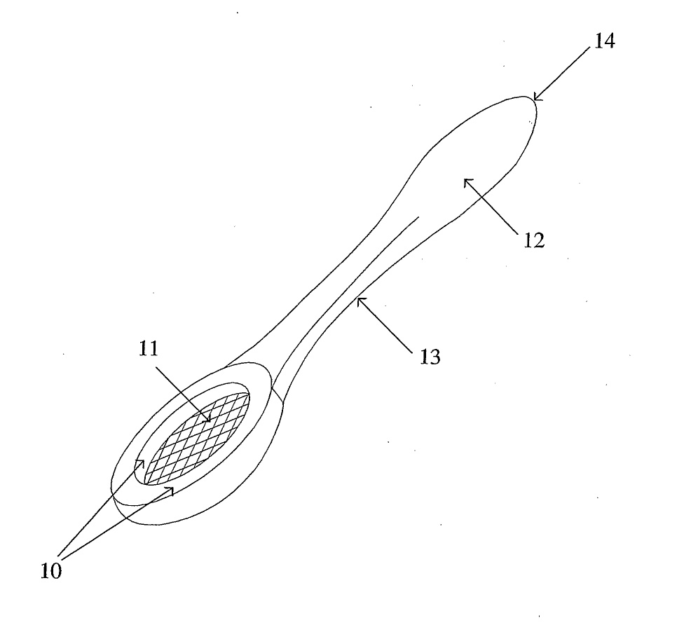

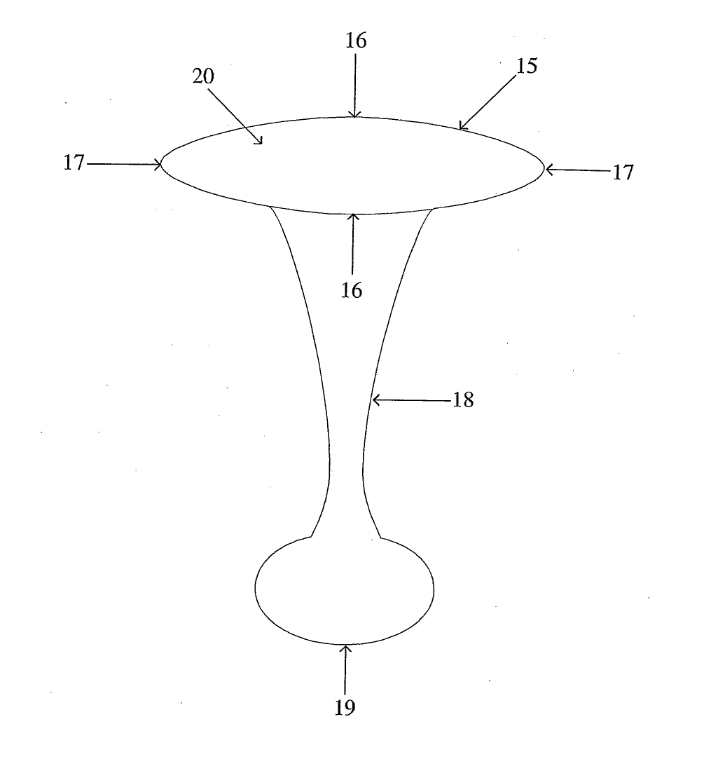

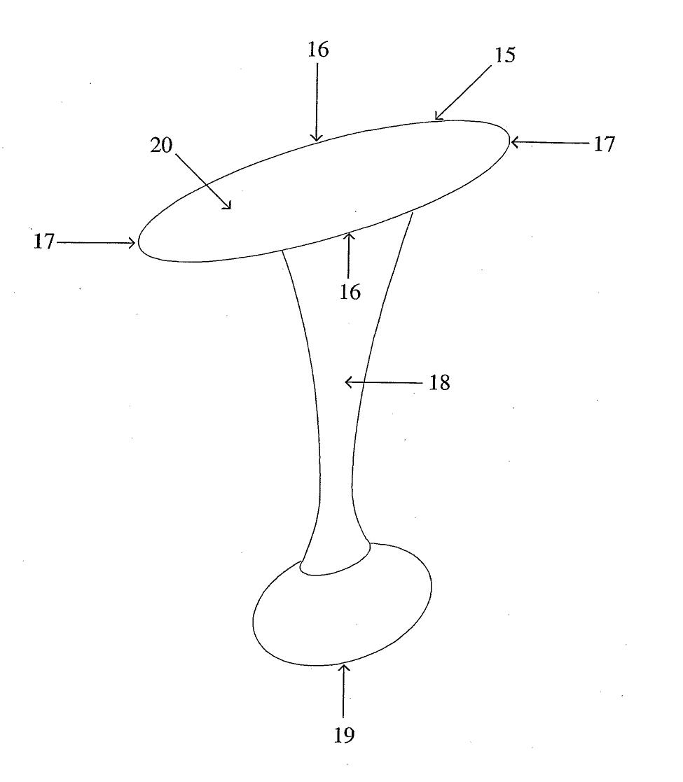

The function of the whole of the upper part of the spatula is to create the effect of vibrations on the sole of the foot and is to be used in conjunction with its sister tool the Hammer (FIGS. 17 and 18). The head of the Hammer (15) should be of such a weight to create the force needed to result in a vibration that is powerful enough to carry through the Spatula tool and then continuing onto the sole of the foot. The upper part of the spatula tool (9) is circular in shape and is quite similar to that of a ‘lollipop’ design, with a lipped edge (10) (approximately 4 mm in width) surrounding a flat thin centre (approximately 20 mm in diameter and approximately 2-3 mm thick). Preferably the Spatula head should be thin enough to allow vibrations to travel through the device to the sole or top of the foot after the top of the tool is struck with the Hammer implement (described in further detail below). The rounded/lipped edges of the circular spatula head (see item 10 in FIGS. 13 and 14) help to stabilise the tool during application as well as providing a ‘bull's-eye’ marking for the flat centre of the upper portion of the tool (11) for the user to avail of when striking down onto that point with the hammer. The lipped outer edge provides a focus point for the hammer to strike but it also ensures that the Hammer point being used (17) remains in place and does not slip off the Spatula onto the foot, thus providing both comfort and security to the user whilst also ensuring that no area of the tool will ‘dig’ or ‘gouge’ into the recipient during the application of vibrations to the sole or top of the foot. The Spatula tool is approximately 140 mm in length, and approximately 25 mm wide at its flat, lollipop top, tapering down into a flat middle that is approximately 15 mm wide and 1 mm thick and subsequently graduates out and downwards into a cylindrical bottom that is, at its widest, approximately 20 mm in diameter (12), which then further graduates inward and downward to form a fine, teardrop point at the very bottom of the tool (14). The upper part of the Spatula tool can be used all over the sole or top of the foot and is small and agile enough to be manipulated into tight areas (around the toes) or difficult, spatial areas such as the arch or top of the foot, to create an effective, vibrating massage. The function of the lower part of the device (14) is to carry out Reflexology pressure point movements in addition to smaller, more focused petrissage movements for smaller, harder to access parts of the foot. The lower part of the tool (12 and 14) consists of a graduated cylindrical, teardrop shape that is approximately 20 mm in diameter at its widest point and requires no application of the hammer at all in order to carry out its function. The user grips the tool in its middle section (13) and then presses the teardrop bottom (14) onto a designated spot in firm, tight rotations from the user's wrist, in a gentle.‘grinding’ motion to achieve Reflexology pressure points or wider circles to achieve a localised petrissage. The rounded teardrop end (14) is wide enough to achieve a balanced and effective pressure and therefore avoids poking the recipient when the application of deep pressure points is required. The circular proportions of the base of the present invention can successfully negotiate difficult areas that the limited spatial range of the foot entails, such as the ball, top and digits of the foot with ease for the user and comfort for the recipient to ensure a successful foot massage.

There are two functions with regard to the middle part of the device (13). Firstly, it connects the upper part of the tool (9) to the lower part of the tool (12) and vice versa and secondly, it allows the user an area to grip and apply downward pressure when applying Reflexology pressure points or focused petrissage on the sole or top of the foot with the bottom part of the tool (14). The middle part of the tool (13) graduates down from the flat and wide upper part of the Spatula (9,11) into a flat, wide middle, which then extends downwards to become cylindrical in shape. It then grows outwards becoming bulbous (12) and then graduates inwards and downward to form the teardrop bottom (14).

The upper (9) and lower (12) parts of the device, though carrying out separate functions (the upper part (9) involving vibrations and interaction with the Hammer implement and the lower part (12 and 14) involving petrissage and Reflexology pressure points requiring no interaction with the Hammer implement) are dependant upon one another in order for each section (the lower and the upper parts of the device) to fulfill their separate functions. In order to achieve the vibrations effect that the upper part of the device (9) is designed, the user must avail of the lower parts of the device that being the middle (13) or, alternatively, (12) to position the upper part of the tool into place upon the sole or top of the foot receiving vibrational massage. By holding the lower orb base (12) in between the user's thumb and forefinger, the upper part of the tool can be firmly manipulated into place and the user's other hand is then free to wield the Hammer implement (15,17) onto the centre point of the Spatula (11) where the upper part of the tool makes contact with the sole or top of the foot. Likewise, in order to carry out the petrissage and/or Reflexology points that the lower part of the tool (14) has been designed for, the user needs to approach the tool from above, gripping the middle base (13) or bulbous lower base (12) with the thumb and forefinger (subsequently making a fist around the upper part of the tool) and utilising the upper part of the tool (9) as a means of steadying the user's grasp by filling the user's fist and allowing the user to lean against it for support. This creates a controlled pressure for petrissage/Reflexology points that the recipient will benefit from but will not put undue pressure on the user in any way.

The Hammer implement may be in the region of approximately 140 mm in length and is comprised of three sections: an upper elliptical hammer ‘head’ (15)), a graduated, middle (18) and an orb-shaped base (19). The hammer's ‘head’ is both elliptical and ‘torpedo’ shaped—the hammer head could even be described as near resembling the shape of a slightly deflated rugby football. The hammer head is approximately 90 mm from end (17) to end (17). The width of the hammer head is graduated. It is widest in the middle (16) (that being approximately 30 mm in width and depth) that graduates down to a rounded point on both sides (17) (this provides the Hammer's head with both a striking point and a counter-balance for accurate aim and striking power). The middle section (18) is approximately 75 mm in length and connects with both the upper hammer head portion (15) and the bottom orb-shaped portion (19). The middle section also varies in width. The upper middle section connects to the bottom of the Hammer's head and is approximately 30 mm wide and approximately 15 mm thick, being a flat surface, which graduates downwardly becoming cylindrical in shape, decreasing in width until in reaches a minimum of approximately 10 mm-15 mm in width, roughly three-quarter's distance down the length of the middle section (18), whereby it then gradually increases outwardly until it reaches the top of the orb-like base of the tool (19). In addition to the width gradually decreasing downwardly from the upper portion of the middle section to the middle and lower portions of the middle section, it also changes in depth. The uppermost portion of the middle section (the point where it connects with the bottom of the Hammer's head of the tool (15)) is flat and is approximately 15 mm thick in depth; however, the middle section gradually tapers in depth until it becomes cylindrical in shape, approximately halfway down the length of the middle section. It then continues to taper gradually downwards until reaching its minimum depth of 8 mm-10 mm and width of approximately 12 mm-15 mm (that being approximately 50 mm in circumference), whereby it then begins to graduate outwardly in width and depth until it reaches approximately 20 mm in width and connects to the Hammer's orb-like base (19).

Each portion of the hammer tool (that being the Hammer's head (15), middle section (18) and the orb/circular base (19) described above) has two functions.

The Hammer head's (15) first function is to provide a hammer-like striking point in conjunction with its sister Spatula tool to provide vibration therapy as part of a foot massage. This is achieved (as described above in the Spatula section) by using one hand to place the flat uppermost part of the spatula tool (9) on a specific part of the sole or top of the foot and then (with the other hand) firmly grasping the lower portions of the Hammer tool (this being either the bulbous section (19) or the lower part of the middle section (18) or both) and striking down upon the Spatula's centre (11) (that being the thin, flat portion of the circle within the lipped circular edges (10)) with one of either the two rounded tips of the Hammer's head (17), thus causing a vibration that will filter down to the recipient's foot. The second function of the Hammer's head is to provide ‘du poing’ effleurage or general effleurage motions to either the sole or top of the foot as part of a foot massage. This is accomplished by turning the Hammer implement upside down, firmly grasping the lower portions of the Hammer tool (this being either the bulbous section (19) or the middle to lower part of the middle section (18) or both) and pressing the tubular middle portion of the upper portion of the tool (20) in sweeping upward or downward motions across the sole or top (though usually more gently on the top of the foot as this is a bonier area) of the foot thus providing the soothing effleurage movements to the foot that are both relaxing and provide movement of blood and lymph to and from the area.

The first function of the lower, bulbous part of the device (19) is to provide a gripping point and counterweight that will aid the Hammer's head (15) when striking down on the Spatula tool (11) during the employment of vibrational massage. The second function of the lower portion of the device (19) is to carry out the more generalised petrissage movements for the sole of the foot. The bulbous part of the Hammer tool (19) comprises a circular orb that is approximately 40 mm-50 mm in width and approximately 30-35 mm in height (roughly 140 mm in circumference). The movement is achieved by firmly grasping either the Hammer's head (15) or the middle portion (18) or both of the tool from above and applying pressure down onto the lower orb (19) of the tool in circular motions from the user's wrist. The orb is wide enough to achieve a balanced and effective pressure and therefore avoids poking the recipient when the application of petrissage is required to loosen muscular tension. The circular proportions of the orb-base (19) can successfully negotiate difficult areas that the limited spatial range of the foot entails, such as the ball, the heel and the arch of the foot with ease for the user and comfort for the recipient to ensure a successful foot massage. Because the orb-base of the Hammer (19) is larger and rounder than the teardrop base of the Spatula (14) it is more effective in larger petrissage motions that can be applied to the wider and flatter spaces of the foot.

The first function of the middle portion (18) is to connect the upper part of the tool (15) to the lower part of the tool (19) and vice versa and secondly, it allows the user an area to grip and apply downward pressure when applying the sweeping motions of ‘du poing’ effleurage with regard to Hammer's head (15, 16, 20) and, likewise, the downward pressure needed for the more generalised petrissage motions on the sole of the foot that are applied with the orb-like bottom part of the tool (19). The middle (18) can also be gripped when using the Hammer for tapping down onto the Spatula when employing vibrations onto the foot.

Such versatility, in application or ease of use on the foot, is simply not available through other massage tools currently available or described in literature. In addition, its many purposes are achieved through its upper and bottom-most parts, both designed to provide adequate support to the wrist and allowing for the application of the increased pressure needed to achieve deep petrissage or pressure points as well as vibrational massage, which can be of great benefit to the recipient to relieve tension in the feet. One of the benefits of this invention is that regardless of the intensity of the pressure, such pressure will be evenly distributed through the device without exhausting the user while providing relaxation to the recipient of such a massage.

It is also envisaged that the massage device of the present invention does not require the application of oils or lubricants, although such lubricants can be used in accordance with the desire of the user and/or recipient. The set is comprised of two devices designed to be used in conjunction with its sister implement as a unit, however, each device can be used alone as an individual tool thus increasing the versatility of employment. The device(s) can be completely solid and can be any colour, according to the manufacturing material used.

The present device may be fashioned from any durable material such as plastic, stone, resin, wood or metal. The device requires no use of lubricants but can such lubricants be used with them if desired. However, if the device were to be used with oils or other such lubricating agents then it would be desirable to have the device made from an easily washable material. It is also possible for both parts of the foot device set (i.e. Hammer and Spatula) to be made of a material that can be heated, for example, by using hot water or even a microwave and such material should hold the heat for a sufficient period of time (without scalding or burning either the user or the recipient with the heated device during massage), so that the recipient receives the benefit of the use of heat during a massage. Alternatively it is possible for the upper quadrant of the Hammer device (15) to be hollow and a battery-operated heating and/or infrared device to be inserted for heat application during massage or a vibrating mechanism inserted into the Hammer's head (or even the orb-shaped base (19)) to enhance the vibrational effect of the Hammer on the foot when applying du poing effleurage. Novelty shapes can be inserted, especially into either end of the Hammer implement to suit aesthetic or seasonal tastes. Likewise, they can be hollow and filled with air or inert gas to make the device lighter The device(s) can be any colour, according to the manufacturing material used.

Head Tool

There are several mechanical devices on the market providing only rapid vibrations to the recipient's scalp either through a mechanical brush or a basic implement that is placed against the scalp and held in one position (usually awkwardly as most mechanical massage devices do not cater for head massage). The only non-mechanical product known on the market attempting a head massage movement is marketed as Head Trip (the “Head Trip”), which is a device made of long, thin metal prongs that project out from a central, thick, wooden handle. This device conducts stroking movements quite successfully along the whole of the scalp simultaneously in an up and down sweeping motion that is controlled by the hand-held central handle in an up and down motion only. This simple up and down stroking movement is the only movement this device can perform and its use is limited to the scalp only. The current proposed head device also carries out the aforementioned stroking device but can do so in any direction, both in large and small sweeping motions. In addition, the proposed device can also conduct compression and waving movements, as well as Swedish massage movements on the neck and shoulders, thus completing a full Indian head massage. Furthermore, the proposed head device has the added bonus of having the space within the tool to house a battery-operated heat and/or vibratory device to achieve a mild, heated vibration for a more effective head massage experience.

The present invention is innovative in that this novel head/scalp tool provides an effective and invigorating massage to the recipient while the design provides maximum comfort and protection to the user of the present invention. Again, like the other tools forming part of the all-over body massage kit, this tool is completely self-contained and hand-held with no moving parts or mechanical attachments.

The upper portion of the head/scalp device (called the “Scratcher”) comprises a series of individual finger rings or notches interconnected to each other. In a preferred embodiment, the Scratcher comprises three finger rings (21) and the fourth finger (perhaps the ‘pinkie’ or any of the user's fingers not already inserted into the other finger holes) is accommodated by a depression on outer rim of the lower half of one side of the upper portion of the tool (24), thereby accommodating right or left-handed use. For the application of the scalp portion (that being the stroking, waving and compression movements) of the Indian Head massage, the tool can be utilised in one of three hand positions. The first position requires that the tool is approached from above over the slightly domed upper portion of the device (22) with the hand in the prone position (palm facing downwards) and the fingers are inserted into the ring portions in a backwards move whereby the palm rests on the top edge of uppermost part of the tool (22). The fingers are then clench upwards thus forming a firm fist. The second position entails the same approach from above and the palm being in the same prone position, however, instead of inserting the fingers into each individual ring, the fingers are placed in the areas in between (27) the extensions or ‘teeth’ (25) projecting from the underside of the upper part of the tool and then clenched upwards to produce a firm grip. The third position entails the fingers (the palm being in a prone position) being inserted in a forward motion into the ring portions, the remaining tips fingers pressing against the side and down onto the lower portion of the tool which still allows a firm grip and confident manipulation of the tool. In all options, the device becomes virtually part of the fist, the wrist is supported and the user can manipulate the tool's extension to confidently and effectively carry out the Indian Head massage movements of scraping (combing the bottom part of the ‘teeth’ through the hair whilst pressing gently against the scalp); waving (dragging the bottom part of the ‘teeth’ in wave-like motions in a concentrated area) and compressions (pressing the bottom of the ‘teeth’ firmly but gently on stationary parts of the scalp for 3-4 seconds) on the scalp with minimal effort and can continue doing so for long periods of time, thus benefiting the recipient. The general rule for hand positioning with regard to using this tool is that the closer the hand is to the point of contact, the less pressure (because the momentum comes from wrist/hand movements only) and, likewise, the further the applicating hand is away from the point of contact, the greater the potential pressure (because the momentum comes from shoulder, wrist and hand movements, thus creating more force).

The bottom most portion of the present massage device is designed with a plurality of pillar-like extensions (25) (otherwise known as “teeth”) protruding from both sides of the bottom most edge (underside) of the upper portion of the tool. These teeth preferably are positioned in two rows of three and placed in the spaces lying approximately under the three finger rings (in order for the second hand grip position described in the proceeding paragraph to be accomplished). It would also be possible for this tool to have additional rows of teeth or even one row of teeth as it is simply important that any such teeth incorporated into this tool are spaced such that the user can place his or her fingers between the teeth to use as a finger gripping point. This positioning creates a balance thus distributing the weight of the hand pressing downward during the massage movements of waving, stroking and compressions without discomfort to the user or the recipient. The teeth may range in length from approximately 50-55 mm and are roughly spaced 25 mm apart within each row and each row being spaced 7 mm-8 mm apart from the other. The ends of the teeth (the points that connect with the recipient's scalp) have a quasi-flat surface, with gently rounded edges (similar to that of the top of a matchstick) that allow for freedom of movement (as in waving and stroking) but also provide the firm base needed for compressions without poking or gouging the recipient's scalp. The spacing of the bottom most part of the device as illustrated in FIGS. (21, 22 and 24) allows a free flowing, no-tangle movement when carrying out stroking on the scalp but also affords the tool the more stationary movements of waving and compression. With the rounded edges of the miniature bases (26) and the even spacing of the rows of teeth (27) (which allows space for fingers regarding alternate hand positions), pressure can be applied gently to the scalp from above and the bases of the tool can be rotated and manipulated in waving or circular movements through the rotating or stroking movements of the users arm and/or wrist to allow the kneading movements of waving or the flowing movements of stroking without discomfort to the recipient or user. Furthermore, the tool's teeth can be employed to release scalp tension through the static use of compressions by gently pressing the slightly bulbous bases of the teeth (26) of the tool onto places of particular tension in bursts of 2-3 seconds, again without discomfort to the recipient or user. All the scalp movements above can be used without mechanical vibrations or, as an additional element to the scalp massage, a battery-operated vibrator can be inserted into the upper most part of the tool, thus providing a gentle vibration that will flow through the tool, thus adding a further dimension to the proposed tool.

Alternatively, when working the neck and shoulder areas where the teeth of the device are not applicable, the tool can turned upside down (meaning the gently-arched upper portion of the device (22) is facing downward towards the body) and the fingers can be inserted into the spaces between the extensions (27) (the palm being in a prone position) and the fingers inserted into the rings in a backwards motion or just resting on the outside of the tool, free from the rings (depending on hand size and personal comfort), thus ensuring the fingers are held in place over the part of tool being used and allowing the user to employ the gently-arched dome of the upper part of the tool (22) to apply effleurage and general petrissage to the neck and shoulder areas. Alternatively, the tool can be approached by the hand in the same prone position as above (with the upper portion of the device (22) facing downwards toward the body) and the fingers inserted into the rings but, instead of curling around the tool, the lay loose and flat against the inner ring wall. This still affords firm control of the tool as the hand is held in place by its downward pressure onto the tool and the tool is held in place by downward pressure of the fingers onto the tool and the tool onto the area being massaged, which affords a gentler, slower pressure as the hand is closer to the body in this position. The user can further manipulate the tool for the application of focused petrissage and friction movements by turning the tool on its side and using the rounded, tapered extensions of the upper portion of the tool (23) to apply focused petrissage or frictions on small areas of tension in the neck and shoulders, especially the occipitalis region (that being the lower part of the scalp). In addition, the arch of the upper part of the tool (22) can also be used to scrape across the scalp (with the alternate hand and tool positions mentioned within this paragraph) in a more generalised move to release superficial scalp tension.

The ‘edges’ or ‘corners’ of the device (23), like the bases of the teeth, are gently rounded to provide both comfort to the user and ensure that no area of the tool will ‘dig’ or ‘gouge’ into the recipient during an Indian Head massage sequence either on the scalp or neck or shoulder areas. The upper portion consists of a gently arched dome (22) made of a durable material about approximately 20 mm in height (from top of finger ring (21) to top of uppermost portion of dome (22)) and approximately 120 mm in width (measuring from tapered edge (23) to opposite tapered edge (23)) The upper portion is of an oval shape and is therefore wider in the middle (approximately 30 mm-35 mm) and gently tapers off towards the edges (23), until it is approximately 10 mm-15 mm on either side of the medial and lateral sides of the tool. The varying widths of the upper part of the device are deliberate and are an essential feature of the present invention in that they afford the wide middle portion of the upper part of the tool to be flat enough for the application of effleurage and general petrissage but the tapered edges are concise enough to be applied to the more focused applications of localised petrissage or frictions to the neck and shoulder areas. The whole of the upper part of the device is gradually and gently arched or domed so that there are no edges (again so that nothing scrapes or pinches the recipient's skin) and for maximum fluidity of movement with regards to the user's wrist and the areas being worked. The upper-most part of the device is wide enough to provide a nearly flat and even surface for the wide, sweeping motions of effective effleurage and lymph drainage, yet the dome is small enough to perform focused petrissage movements. As mentioned above, on one side of the outer, lower portion of the upper tool there is a depression flowing downward, which then graduates or ‘drops’ inwards by approximately 25 mm and then levels off to the underside of the upper portion of the tool. This effect produces what can be described as a ‘bite’ out of the lower side of the upper portion of the tool or, alternately, a ‘bump’ inwards or a side ‘notch’ before connecting back to the underside of the upper portion of the tool from where the teeth (25) protrude. This depression (24) provides a secure resting place for the user's fourth finger or ‘pinkie’ (or whichever finger the user finds most comfortable) which results in a more comfortable and secure grip of the tool as a whole.

A further advantage is that the rotating motions of petrissage can be performed easily with both the middle and side portions of the upper oval and, because the present device has such an even and generous spatial range, a maximum coverage can easily be achieved. Due to the device's arched and varying circular proportions, the present invention can successfully negotiate difficult areas such as the nape of the neck with ease and if more concentrated petrissage or friction movements are required, the thinnest part of the device allows concentrated circular and sawing motions or even static pressure with even the most concentrated pressure. Such versatility, in application or ease of use, is not available through other massage tools currently available or described in literature.

In addition, it's gentle, wide arch and rounded features result in adequate support being provided to the wrist, through the upper and lower portions of the invention, allowing for the application of the increased pressure needed to achieve deep massage which can be of great benefit to the recipient to relieve muscular tension and improve blood flow. One of the benefits of this invention is that regardless of the intensity of the pressure, such pressure will be evenly distributed through the device without exhausting the user and it provides beneficial massage and relaxation to the recipient of such Indian Head massage applications.

Face Tool

With regard to the facial tool it is not believed that there are any non-mechanical facial tools in the public arena attempting facial massage manoeuvres other than certain examples of devices supplying simple vibrations to the face. The facial tool of the present invention provides so much more to the recipient.

The facial tool of the present invention (called the “Smoother”) is innovative in that this novel device provides an effective and relaxing massage to the recipient while the design provides maximum comfort and protection to the user of the present invention. The present device may be fashioned from any durable material such as plastic, stone, resin, wood or metal. However, if the device were to be used with oils or other such lubricating agents then it would be desirable to have the device made from an easily washable material. It is also possible for the device to be made of a material that can be heated, for example, by using hot Water or even a microwave and such material should hold the heat for a sufficient period of time (without scalding or burning either the user or the recipient with the heated device during massage), so that the recipient receives the benefit of the use of heat during a massage. Alternatively, it is possible for the bottom quadrant of the device (7) to be hollow and a battery-operated heating and/or infrared device to be inserted for heat application during massage.

The upper portion of the device (6a) comprises a self-contained, gently rounded arrowhead apex (6b) Owing to the dextrous design of the tool, the device can be used in a number of positions involving the top and bottom portions of the tool, as well as the concave middle portion (8a). The whole of the tool has been designed to be used for various different massage applications on various parts of the face. The uppermost point of the tapered dome/arrowhead of the tool (6b) can be used either for focused petrissage on localised areas and/or for all facial pressure points while the rounded, crescent bottom of the tool (7) can be used for any effleurage or general petrissage movements required over the larger areas of the face. The flatter sides (6a) (the sides that graduate from the arrowhead point (6b) of the upper portion of the device can also be used for gentle effleurage on smaller or bonier parts of the face. The concave u-bend middle portion of the tool (8a) is specifically designed to be used for (a) holding and manipulating the tool and (b) for massaging and firming the jaw line.

There are two hand positions for carrying out massage movements with either the top or bottom portions of the tool and are relatively similar for both employments. The first hand position when carrying out facial effleurage with the bottom portion of the tool (7) entails approaching the tool from above with the hand in the prone position (palm facing downwards). The middle of palm of the hand then rests on the uppermost point of the tool (6b) and the hand closes over the tool with the fingers pointing downward in a backward grip-like motion. The concave nature of the middle portion of the present device (8a) affords the user depressions on either side of the middle tool that the fingers of the hand will fit naturally into (for instance, the forefinger and middle finger on one side and the ‘ring’ finger and ‘pinkie’ on the other) which results in a comfortable and secure grip once the hand is contracted into a fist. The second position sees the palm still in a prone position but instead of the hand placed above the upper portion of the tool (6a), the palm remains flat and the fingers extended (but not rigid) or slightly curled downward (depending on the personal comfort of the user) whereby they are placed either side of the bottom most depressions of the middle portion of the tool. The tool is held in place by the downward pressure of the lower part of the tool (7) against the recipient's face and is guided and further steadied by the pressure of the fingers pushing inward against the tool's central core and downward against the lower portion of the middle quadrant of the tool. The lower portion of the tool (7) is then pressed gently upon the recipient's face and guided along its course through the gentle movements of the wrist and/or arm of the user. Either positioning affords a firm grip over the tool thus making the device a virtual extension of the hand and allowing the wrist to be supported and move freely in order to manipulate the crescent-shaped bottom part of the tool (7) in carrying out the application of effleurage or generalised petrissage over all portions of the face. Generally, the first aforementioned position is a ‘stronger’ position in which more force can be applied from the top of the tool downward while the second aforementioned position is a ‘gentler’ position, thus using less pressure from the middle part of the tool downward. The general rule for use with this tool is that the closer the hand is to the point of contact, the less pressure (as impetus will come from the wrist and hand only) and, likewise, the further the applicating hand is away from the point of contact, the greater the potential pressure (as the impetus will come from the shoulder, hand and wrist, potentially creating more force).

The application of focused petrissage and the application of facial pressure points involves the uppermost part of the tool (6b) and the user will therefore have to turn the tool upside down so that the bottom crescent-shaped part of the tool (7) is facing upwards and the uppermost point of the tool (6b) is pointing downwards towards the face. In this position, the tool is approached from above with the hand in the prone (palm facing downwards) position and the palm rests on the outer edge of the bottom-most part of the tool. Again, the concave middle of the tool (8a) provides the space needed for the for the fingers to allow the hand to close in a backwards/downwards grip over the lower part of the tool (7), thus ensuring a solid, comfortable grip and allowing the wrist to rotate freely in the application of slow, localised petrissage or facial pressure points to varying degrees of required pressure with no strain on the user at all. Likewise, for a lighter, slower movement, the hands can be positioned as explained above in position two. The palm is still in a prone position but instead of the hand placed above the upper portion of the tool (7), the palm remains flat and the fingers extended (but not rigid) or slightly curled downward (depending on the personal comfort of the user) whereby they are placed either side of the upper most depressions of the middle portion of the tool (now the bottom-most depressions as the tool is in an upside down position). The tool is held in place by the downward pressure of the upper tool (6a or 6b) against the recipient's face and is guided and further steadied by the pressure of the fingers pushing inward against the tool's central core and downward against the upper portion of the middle quadrant of the tool. The upper tool (6a and 6b) is then pressed gently upon the recipient's face and guided along its course through the gentle, circular movements of the wrist of the user. In addition, the soft-edged descending sides of the uppermost part of the tool, i.e. the sides of the ‘arrowhead’ (6a) can be used for general effleurage on the smaller areas of the face or on the forehead, where such sweeping movements need to be gentle and controlled due to the boniness of the area.

Finally, the concave, u-bend middle portion of the tool is designed specifically for use in massaging and toning the facial jawline. In this application, the tool is returned to its original position, that being the uppermost portion (6a and 6b) of the tool facing upwards. In this move, the outermost edges (8b) of the upper portion of the tool (6a) and the lower portion of the tool (7) are applied to both the upper and lower portions of the jawline simultaneously while the hollow provided by the middle portion of the tool (8a), having been designed to follow the natural curve of the jawline, fits and accommodates the projection of the jawline. The tool is applied to the jawline in very slow and deliberately paced sweeping motions. The user can start from one end of the jawline, that being the area of the masseter muscle in front of the ear and follow the jawline to the chin in one continuous, firm sweeping motion. This will help alleviate tension and tone all the facial muscles of the jawline both above and below the mandible.

In general, the tool is made of durable material and stands about approximately 80-90 mmmm in total height. The ‘edges’ or ‘corners’ of the device that make up the upper and bottom of the middle portion (8b) are also to be gently rounded to provide both comfort to the user and ensure that no area of the tool will ‘dig’ or ‘gouge’ into the recipient during a facial massage. The upper portion consists of a graduated dome (or arrowhead) (6a) the very top of the upper portion of the tool being a point (6b) (approximately 15-18 mm in depth), which then tapers down on both sides to two outermost points that then begin to comprise the middle section of the tool, each side (6a) going away from the top of the arrowhead being approximately 50 mm long). The uppermost portion resembles a soft arrowhead and is approximately 37 mm-40 mm high and, at its widest point, that being the bottom most part of the upper portion of the tool, would be approximately 90 mm across. The middle part of the tool comprises of three parts—the extended bottom of the upper portion of the tool (8b), a concave u-bend (8a) and the extended upper edge of the bottom portion of the tool (8b). Both the extended bottom of the upper portion of the tool and the extended top of the bottom part of the tool round off at their widest points (8b) creating a void of approximately 30-35 mm which allows space for the mandible and then graduate inwards, meeting in the middle to create the soft u-bend effect that is the centre of the tool (8a) and which provides the space needed to provided a gripping point for fingers when utilising the tool in its various moves and also to facilitate the jawline. The bottom portion of the tool is (7) an extended crescent shape that is approximately 90 mm wide and 37 mm-40 mm In height (i.e. for bottom most point of crescent to centre of u-bend (8a)). The varying widths of the upper, middle and lower parts of the device are deliberate and are an essential feature of the present invention. The crescent-shaped bottom portion of the tool (7) must be wide and flat enough to perform effleurage and general petrissage movements. The whole of the upper part of the device comprises of a singular upper point (6b) that is wide enough to facilitate the application of focused petrissage and pressure points whilst remaining round enough to allow the rotating motions involved in both applications to be performed with ease and comfort. The uppermost portion of the tool (6a) graduates gently downwards from its uppermost point to a rounded edge on both sides. Both the extensions of the upper and bottom portions of the tool (8b) are rounded so that there are no edges (again so that nothing scrapes or pinches the recipient's skin) and that provide maximum fluidity of movement with regards to the user's wrist and the areas being worked.

Due to the device's arched and rounded circular proportions, the present invention can successfully negotiate difficult areas such as the jawline, forehead, temples and cheek areas with ease and, if more concentrated petrissage or pressure points are required, the thinnest part of the device, that being the top most point of the upper portion of the device (6b), allows concentrated circular and sawing motions or even static pressure with even the most concentrated pressure. Such versatility, in application or ease of use, is not available through other massage tools currently available or described in literature. In addition, its gentle, wide arches (8a) result in adequate support being provided to the wrist, through the upper and lower portions of the invention, allowing for the application of the varying degrees of pressure needed to achieve either effleurage, petrissage and/or facial pressure points which can be of great benefit to the recipient to relieve muscular tension. One of the benefits of this invention is that regardless of the intensity of the pressure, such pressure will be evenly distributed through the device without exhausting the user and it provides beneficial facial massage and relaxation to the recipient of such a massage. It is also envisaged that the massage device of the present invention can be used with massage oils, lotions or other such suitable lubricants. The design is completely self-contained, with no moving parts or detachable elements.

While the present massaging device has been described with various preferred embodiments thereof, it will be understood that this description is intended to illustrate and not to limit the scope of the invention. The optional dimensional relationships for all parts of the invention are to include all variations in size, materials, shape, form, function and operation, which are deemed readily apparent and obvious to those skilled in the art. For instance it is envisaged that different size tools may be utilised for various hand sizes (i.e. small, medium, large and extra large) and therefore the measurements and dimensions stated within this description of the invention are presented solely to illustrate relative distances between different focal points of each of the hand-held tools comprising the tool kit or set. All equivalent relationships to those illustrated in the figures and described in the specification are intended to be encompassed in this invention what is desired to be protected is defined by the following claims.

1. A hand-held self-contained massaging device for body massage comprising a lower portion which is a hand grip (4) comprising a plurality of finger rings or notches (2) for placement of a user's fingers in such rings and wherein such finger rings are arranged consecutively and connected to each other and are of a dimension to accommodate the fingers of one hand; wherein the bottommost portion of the massaging device or handgrip is of a convex nature (4) and further comprising an arched dome member (1) connected to the upper surface of all of the rings, wherein said arched dome member is of a size suitable for effective general effleurage and lymph drainage and is also suitable for effleurage on a recipient's limbs.

2. The massaging device of claim 1, wherein the upper part is gently tapered at each end (3) of the arched dome member (1) and wherein such gently tapered ends (3) are suitable for focused petrissage and friction massage movements.

3. The massaging device of claim 1, wherein the upper part is hollow and filled with air or another inert gas.

4. The massaging device of claim 1, wherein the upper part is hollow and filled with an inert liquid or a battery-operated heating device or an infrared heating device.

5. The massaging device of claim 1, wherein the handgrip is hollow and filled with an inert liquid or a battery-operated heating device or an infrared heating device.

6. The body massage device of claim 1, wherein the handgrip is concave (5).

7. A hand-held self-contained massage device for use in performing Indian Head massage including stroking, waving and compression movements comprising an uppermost portion (22) having a solid arched dome, a plurality of finger holes or notches (21) arranged consecutively and interconnected and are of a dimension to comfortably accommodate the fingers of the user's hand and wherein the device further comprises an outer finger notch (24) on the side of the uppermost portion of said device and wherein said uppermost portion of the device further comprises gently tapered edges (23) for use in focused petrissage and wherein said tool additionally comprises a plurality of teeth (25) of a size and dimension to enable free-flowing, no-tangle movement when stroking, waving or using compression movements on the scalp of a recipient.

8. The hand-held massage tool as claimed in claim 8, wherein sard massage tool is inverted and the user thereby uses the base of the teeth (27) as a grip and thereby using the uppermost portion of the tool (22) for massage movement.

9. The hand-held massage tool as claimed in claim 8, wherein said teeth further comprise rounded tips (26) to allow easy movement of said tool across the scalp without tangling the recipient's hair.

10. The massaging device of claim 8, wherein the upper part is hollow and filled with air or another inert gas.

11. The massaging device of claim 8, wherein the upper part is hollow and filled with an inert liquid or a battery-operated heating device or an infrared heating device.

12. A hand-held massage tool set for use in performing foot massage comprising an interactive hammer implement and a spatula implement, wherein said hammer implement comprises an upper hammerhead (15) which is elliptical in shape with tapered and gently rounded edges (17), a middle section (18) functioning as a hand/finger gripping section connecting said upper elliptical hammerhead to an orb- shaped base (19) and wherein said spatula comprises an upper section shaped in a circular head (9) said circular head comprising a flat disk or rounded centre (11) with a raised lipped edge (10) completely surrounding said rounded centre and said spatula further comprising a connecting middle section (13) for use as a finger/hand grip section and a tear-drop base (12,14).

13. A hand-held massage foot tool as claimed in claim 13, wherein said tapered edge of the upper elliptical hammerhead (17) strikes said rounded centre of the spatula (11) creating vibrations on the point of the recipient's foot where the circular head of spatula tool has placed.

14. A hand-held massage foot tool of claim 13, wherein said tear-drop base of said spatula implement is used for Reflexology pressure point movements.

15. A hand-held massage foot tool of claim 13, wherein the top of the upper hammerhead (15) is used for effleurage massage movements on the foot.

16. A hand-held foot massage tool of claim 13, wherein said orb-shaped base (19) of said hammer implement acts as a counterweight for the hammerhead in performing the striking motion of the hammer-implement to the spatula implement and wherein said orb-shaped base also functions as a device for performing petrissage on the recipient's foot.

17. A massaging device of claim 13, wherein the upper part of the hammer implement is filled with an inert liquid or a battery-operated heating device or an infrared heating device.

18. A massage device of claim 13, wherein the head of the spatula implement or the tear-drop end of the spatula implement is hollow and filled with an inert liquid or a battery-operated heating device or an infrared heating device.

19. A massage device of claim 13, wherein said top elliptical portion of the hammerhead (15) includes a battery-operated vibrating mechanism to maximize vibrational movements on the recipient's foot.

20. A massage device of claim 13, wherein said bulbous end/tear-drop end (12) includes a battery-operated vibrating mechanism to maximize vibrational movements on the recipient's foot.

21. A hand-held self-contained massage tool for use in massaging the face and neck regions of a recipient in need of such massage, wherein said facial massage tool comprises an upper portion (6a) comprising a gently-rounded arrowhead point (6b), a middle section comprising concave u-bend elements (8a) with rounded tapered edges (8b) and a rounded crescent-shaped bottom (7).

22. A hand-held facial massage tool as claimed in claim 21, wherein said gently-rounded arrowhead portion is of a width allowing focused petrissage on localized areas of the face, jaw and neck, including facial pressure points and where such gently-rounded edges (6a) are of a width to allow gentle effleurage on smaller bonier areas of the face.

23. A hand-held facial massage tool as claimed in claims 21, wherein said concave u-bend elements further comprise rounded tapered edges (8b) and the hollow of said u-bends (8a) is such so as to allow the recipient of a facial massage using said tool to follow the natural curve of the recipient's jaw line thus alleviating tension and toning the facial muscles of said jaw line.

24. A hand-held facial massage tool as claimed in claim 21, wherein said crescent-shaped bottom is of a sufficient width and curvature to provide the recipient with generalized effleurage and petrissage in the facial and neck regions and upper shoulders.

25. The massaging device of claim 21, wherein the upper part is hollow and filled with an inert liquid or a battery-operated heating device or an infrared heating device.

26. The massage devices as claimed in claim 1, 8, 13, or 22, wherein said massage tools comprise a set and are used for an all-over body massage.
